(19) United States
(12) Patent Application Publication
(10) Pub. No.: US 2025/0336313 A1
(43) Pub. Date: Oct. 30, 2025

(54) LIFE-LIKE THREE-DIMENSIONAL PAPER ARRANGEMENT

(71) Applicant: FRESHCUT PAPER, LLC, Concord, MA (US)

(72) Inventors: Peter Hewitt, Concord, MA (US); Jonathan Oliveira Aoun, Saugus, MA (US); Jozef Marcin Karpiel, Salem, MA (US); Jori Leigh Dudzikowski, Worcester, MA (US); Madison Leigh Kaylor, Acton, MA (US)

(21) Appl. No.: 18/646,256

(22) Filed: Apr. 25, 2024

(51) Int. Cl. G09F 1/08

(52) U.S. Cl. CPC G09F 1/08

(57) ABSTRACT

A three-dimensional paper arrangement is presented, including at least one section including a first section, the first section having an internal space between a front portion of the first section and a back portion of the first section; a first biasing mechanism coupled to the front portion at a first location and coupled to the back portion at a second location opposite the first location; a second biasing mechanism coupled to the front portion at a third location and coupled to the back portion at the fourth location opposite the third location; and a control mechanism coupled to the first biasing mechanism and configured to selectively adjust the first biasing mechanism into a first position or a second position, the first position biasing the first location and second location away from each other.

### BACKGROUND

### 1. Field of the Disclosure

At least one example in accordance with the present disclosure relates generally to decorative paper arrangements and displays, as well as methods and systems for assembling, storing and biasing said arrangements and displays.

### SUMMARY

According to at least one aspect of the present disclosure, a three-dimensional paper arrangement is presented, comprising: at least one section including a first section, the first section having an internal space between a front portion of the first section and a back portion of the first section; a first biasing mechanism coupled to the front portion at a first location and coupled to the back portion at a second location opposite the first location; a second biasing mechanism coupled to the front portion at a third location and coupled to the back portion at the fourth location opposite the third location; and a control mechanism coupled to the first biasing mechanism and configured to selectively adjust the first biasing mechanism into a first position or a second position, the first position biasing the first location and second location away from each other.

In some examples, the first biasing mechanism includes a fold separating the first biasing mechanism into a first half and a second half, wherein in the first state an angle between the first half and the second half is approximately 180 degrees. In some examples, the first biasing mechanism includes a fold separating the first biasing mechanism into a first half and a second half, wherein in the second state an angle between the first half and the second half is less than 5 degrees. In some examples, the second biasing mechanism is situated adjacent to the first biasing mechanism in the first position. In some examples, the second biasing mechanism includes a first half and a second half, the first half extending from the third location to the fourth location on a first of the control mechanism, and the second half extending from the third location to the fourth location on a second side of the control mechanism. In some examples, when the first biasing mechanism is in the first position, the first half of the second biasing mechanism extends laterally between the third position and the fourth position below the first biasing mechanism, and the second half extends laterally between the third position and the fourth position below the first biasing mechanism. In some examples, the first biasing mechanism is a disk and the second biasing mechanism is a ring. In some examples, the arrangement further comprises a second section including a third biasing mechanism, the third biasing mechanism configured to bias the second section into a three-dimensional position, the third biasing mechanism being coupled to the control mechanism via a strap. In some examples, the first section occupies a greater total volume in the first position than in the second position. In some examples, the paper arrangement is configured to resemble an animal. In some examples, the arrangement includes a second section, wherein the first section resembles the lower body of an animal and the second section resembles the upper body of an animal, the second section including a respective first biasing mechanism and a respective second biasing mechanism. In some examples, the second section is pivotably coupled to the first section.

According to at least one aspect of the present invention, a three-dimensional paper arrangement is presented, comprising: a front side; a back side; an internal space between the front side and the back side; a biasing device situated within the internal space and coupled to the front side and the back side, the biasing device including a disk element and a ring element, the disk element being coupled to the front side at a first location and to the back side at a second location, and the ring element being coupled to the front side at a third location and to the back side at a fourth location, the disk element including a fold separating the disk element into a first half and a second half.

In some examples, in the first position, an angle between the first half and the second half is less than 5 degrees, a first distance, between a first point where the ring element is coupled to the front side and a second point where the ring element is coupled to the back side, is less than in the second position, and a second distance, between a first region of the ring element located halfway between the first point and the second point and a second region of the ring element located halfway between the first point and the second point and opposite the first region, is greater than in the second position. In some examples, in the second position, the angle between the first half and the second half is approximately 180 degrees, and the first region and second region are directly below the disk element. In some examples, the arrangement further comprises a control mechanism coupled to the disk element, the control mechanism extending out of the interior space. In some examples, the disk element includes a slot situated along the fold, the control mechanism passing through the fold and being coupled to the disk element on a side of the disk element opposite the ring element. In some examples, the arrangement further comprises a second internal space having a second biasing device, the second biasing device being coupled to the control mechanism via a strap configured to allow the control mechanism to control a state of the second biasing device.

According to at least one aspect of the present disclosure, a paper arrangement is presented, comprising: a paper upper body configured to resemble the upper body of an animal; a paper lower body configured to resemble the lower body of an animal; and a biasing mechanism coupled within one of the paper upper body or the paper lower body and configured to bias the paper upper body or paper lower body into a display state, the biasing mechanism including a disk element and a ring element.

In some examples, at least one feature of the paper upper body or the paper lower body is operative to control the position of the disk element of the biasing mechanism.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1A illustrates a paper arrangement according to an example;

FIG. 1B illustrates a paper arrangement according to an example;

FIG. 2A illustrates a biasing mechanism according to an example;

FIG. 2B illustrates a biasing mechanism according to an example;

FIG. 2C illustrates a biasing mechanism according to an example;

FIG. 3A illustrates a biasing mechanism according to an example;

FIG. 3B illustrates a biasing mechanism according to an example;

FIG. 4A illustrates a front section of a paper arrangement according to an example;

FIG. 4B illustrates a back section of a paper arrangement according to an example;

FIG. 5 illustrates a diagram of a paper arrangement according to an example;

FIG. 6 illustrates a paper arrangement according to an example;

FIG. 7 illustrates a paper arrangement according to an example;

FIG. 8 illustrates a paper arrangement according to an example;

FIG. 9 illustrates a paper arrangement according to an example;

FIG. 10A illustrates a biasing mechanism according to an example;

FIG. 10B illustrates a biasing mechanism according to an example;

FIG. 10C illustrates a biasing mechanism according to an example;

FIG. 11A illustrates a biasing mechanism according to an example;

FIG. 11B illustrates a biasing mechanism according to an example;

FIG. 12A illustrates a biasing mechanism according to an example;

FIG. 12B illustrates a biasing mechanism according to an example;

FIG. 13A illustrates a paper arrangement according to an example;

FIG. 13B illustrates a paper arrangement according to an example;

FIG. 13C illustrates a paper arrangement according to an example;

FIG. 13D illustrates a paper arrangement according to an example;

FIG. 13E illustrates a paper arrangement according to an example;

FIG. 14A illustrates a paper arrangement according to an example;

FIG. 14B illustrates a paper arrangement according to an example; and

FIG. 15 illustrates a paper arrangement according to an example.

### DETAILED DESCRIPTION

Traditional paper arrangement (e.g., posters) are two-dimensional displays that attempt to simulate three-dimensionality through the rendering of the subject matter in two-dimensions. For example, an image printed on a poster is two-dimensional, but may appear three-dimensional if the artist who created it rendered light and shadow in such a way as to give the poster an appearance of three-dimensionality.

Paper arrangements disclosed herein are three-dimensional, and may include multiple three-dimensional components coupled together to represent animals, vehicles, structures, and other objects. The paper arrangements disclosed herein may also include printed surfaces rendered in such a way as to change (e.g., amplify or reduce) the three-dimensionality of the components.

Furthermore, the three-dimensional portions of the paper arrangements disclosed herein may be configured to switch between a flat (e.g., mostly two-dimensional) storage state, and an expanded (e.g., three-dimensional) display state. Individual portions of the paper arrangements may be expanded independently of other portions of the paper arrangements.

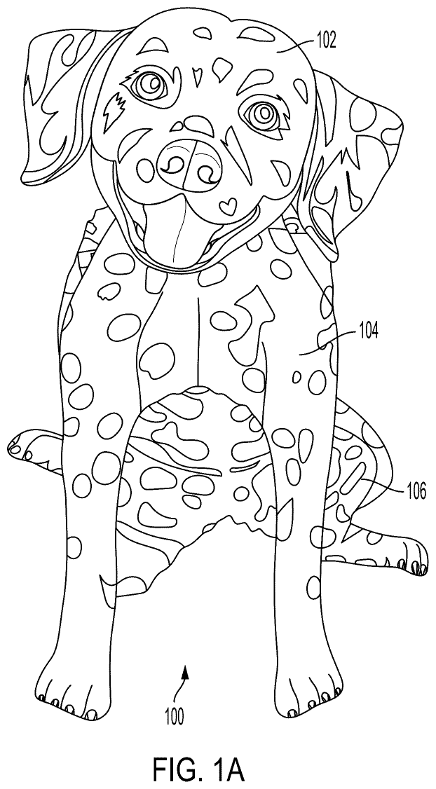

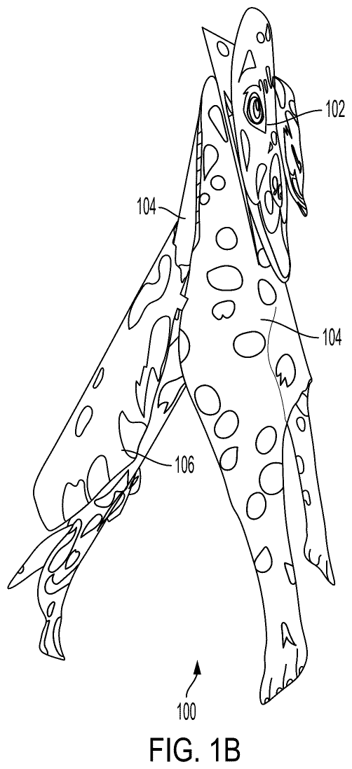

FIG. 1A illustrates a paper arrangement 100 front a front-view according to an example. FIG. 1B illustrates the paper arrangement 100 from a side-view according to an example.

The paper arrangement 100 has the general appearance of a dog, and in one embodiment is configured to sit upright. While the paper arrangement 100 illustrates a generic dog, the paper arrangement 100 could be made to represent any breed of dog, or even specific household dogs. More generally, the paper arrangement 100 may be made to represent any specific or general animal (e.g., a specific household pet), vehicle (e.g., a class of car or specific car), place (e.g., a building or landmark), and so forth. Examples herein may refer to fauna, however, it should be understood that fauna is one example. Other types of objects include vehicles, places, buildings, and so forth.

The paper arrangement 100 includes a plurality of sections, including a first section 102, a second section 104, a third section 106. Each section may include one or more components. For example, the first section 102 may include one or more first section components, the second section 104 may include one or more second section components, and the third section 106 may include one or more third section components.

Each section may include at least one biasing mechanism configured to bias the section into a three-dimensional state (e.g., the display state). For example, the first section 102 includes a biasing mechanism configured to cause the “face” and “ears” to curve forward, and the “mouth” and background elements of the first section 102 to curve backwards. Because the first section 102 is configured to resemble the face and head of a dog, the curving of the various components due to the biasing of the biasing mechanisms gives the paper arrangement 100 additional depth and compliments the illusion of three-dimensionality from the printing on the surfaces of the first section 102 of the paper arrangement 100.

Likewise, the second section 104 may include one or more biasing mechanisms configured to cause the “leg” and/or “neck” sections of the paper arrangement 100 to curve. The third section 106 may also include one or more biasing mechanisms configured to cause the “back” and/or “tail” sections of the paper arrangement 100 to curve.

The sections may be coupled together in various ways. For example, the first section 102 may be foldably, expandably, fixedly, and/or rotatably coupled to the second section 104. The second section 104 may be foldably, expandably, fixedly, and/or rotatably coupled to the third section 104.

The sections may be configured to lay flat against one another when in the storage state. In particular, in the storage state, each component of the first section 102, second section 104, and/or third section 106 may lay flat against each other, such that the volume of the paper arrangement 100 is minimized.

Individual components of the sections may also be coupled together in various ways. For example, the first section 102 may, in some examples, include “ear,” “tongue,” and “face” components. The “ear” and “tongue” components may be rotatably coupled to the “face,” to allow a user to adjust the exact position and character of the tongue and ears.

Various “accessory” components may also be selectively coupled and decoupled to the sections. For example, sunglasses, bibs, scarves, and other accessory components may be coupled to the first section 102, second section 104, and/or third section 106. Each accessory component may also include one or more biasing mechanisms configured to bias the accessory component into a display state.

While curving is discussed above, any three-dimensional biasing may be substituted for curving in the discussion. For example, protrusions and/or protruding, wedges, angles, and so forth.

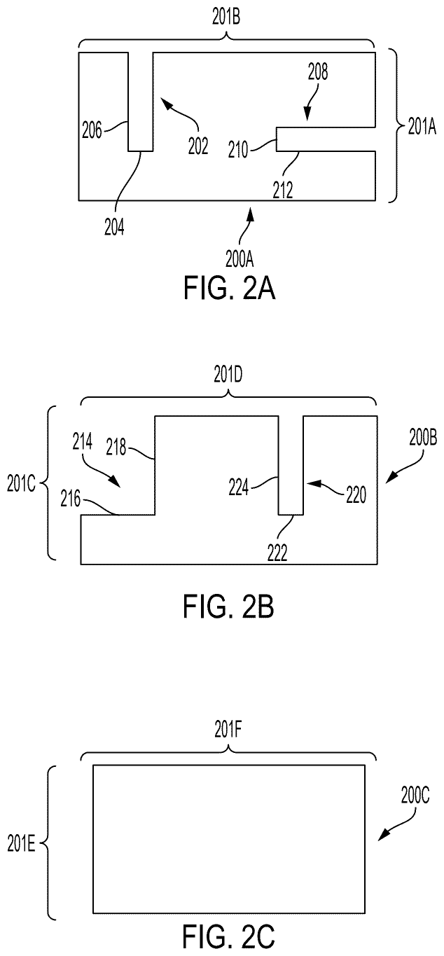

FIGS. 2A-2C illustrates components of a biasing mechanism 200 according to an example. FIG. 2A illustrates a first component 200A according to an example. FIG. 2B illustrates a second component 200B according to an example. FIG. 2C illustrates a third component 200C according to an example.

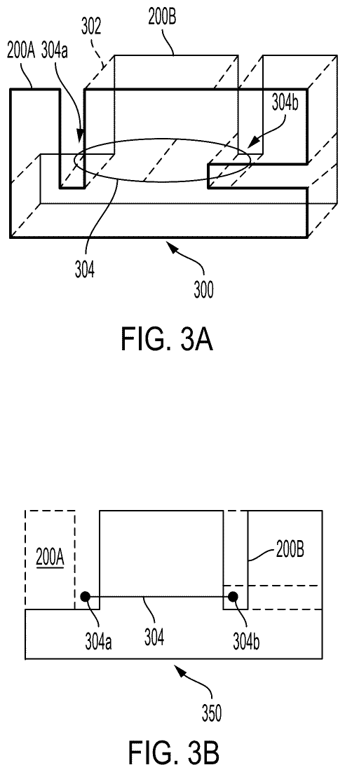

The first component 200A, second component 200B, and/or third component 200C work together to bias sections of paper arrangements into the display state. For example, the first component 200A, second component 200B, and/or third component 200C may be used to bias the first section 102, second section 104, and/or third section 106 of the paper arrangement 100 of FIG. 1 into the display state. In particular, a spring may straddle or loop through the cutouts, providing a compressive force directed to the center of the spring. For example, the biasing mechanism 200 may be implemented using elastomeric bands (e.g., rubber bands) that hold the pieces together, as will be illustrated with respect to FIG. 3.

The first component 200A has a first width 201A and a first length 201B, a first cutout 202, and a second cutout 208. The first cutout 202 is defined by a first edge 204 and a second edge 206. The second cutout 208 is defined by a third edge 210 and a fourth edge 212.

The second component 200B has a second width 201C and a second length 201D, a third cutout 214 and a fourth cutout 220. The third cutout 214 is defined by a fifth edge 216 and a sixth edge 218. The fourth cutout 220 is defined by a seventh edge 222 and an eighth edge 224.

The third component 200C is defined by a third width 201E and a third length 201F.

In various examples, the first width 201A, second width 201C and/or third width 201E may be the same (e.g., 2 cm, 10 cm, and so forth). In various examples, at least two of the first width 201A, second width 201C, and/or third width 201E may be the same. In various examples, none of the first width 201A, second width 201C, or third width 201E may be the same.

In various examples, the first length 201B, second length 201D, and/or third length 201F may be the same. In various examples, at least two of the first length 201B, second length 201D, and/or third length 201F may be the same. In some examples, the first length 201B and the second length 201D may be the same, and the third length 201F may be different. In some examples, the first length 201B, second length 201D, and third length 201F may all be different from one another.

The first cutout 202 is configured to hold an end of a spring, such as an elastomeric band (e.g., a rubber band). The second cutout 212 is configured to hold an end of a spring, such as an elastomeric band. The fourth cutout 220 is configured to hold an end of a spring, such as an elastomeric band, as well. In some examples, the third cutout 214 may also be configured to hold an end of a spring. In various examples, a first end of the spring is retained by the first cutout 202 and/or the third cutout 214, and a second end of the spring is retained by the second cutout 208 and/or fourth cutout 220.

The location of various edges may correspond from one section to another when the sections are laid atop one another in the positions illustrated in FIGS. 2A, 2B, and 2C. For example, the first edge 204 may correspond to a portion of the fifth edge 216, and the second edge 206 may be the same length as the sixth edge 218. Likewise, the third edge 210 may correspond to a portion of the eighth edge 224, and the seventh edge 222 may correspond to a portion of the fourth edge 212. Thus, a portion of the area of the first cutout 202 may overlap with and/or correspond to a portion of the area of the third cutout 214, and a portion of the area of the second cutout 208 may correspond to a portion of the area of the fourth cutout 220.

In some examples, the first section 200A, second section 200B, and third section 200C may be coupled together, for example, via double-sided tape, adhesive, pins, or other similar fixing mechanisms.

FIG. 3A illustrates an isometric perspective 300 of the first section 200A of FIG. 2A and the second section 200B of FIG. 2B overlaid with respect to one another, with a plurality of dashed traces 302 indicating the correspondence between various vertices and/or edges of the first section 200A and second section 200B, according to an example. FIG. 3A also includes a spring trace 304 indicating the positioning of the spring (in the form of an elastomeric loop or band

FIG. 3B illustrates an overlapping perspective 350 of the first section 200A of FIG. 2A and the second section 200B of FIG. 2B without any offset between the first section 200A and second section 200B according to an example. Thus, in some example, FIG. 3B illustrates the same arrangement of the first section 200A and the second section 200B as FIG. 3A, but from a different perspective.

The spring trace 304 includes a first end 304a and a second end 304b. In general, the first trace 304 indicates that the spring (e.g., elastomeric band or loop) loops around an outside portion of the first section 200A and second section 200B, through the cutouts, and back around (also on the outside). FIG. 3A shows the loop. FIG. 3B shows where the first end 304a and second end 304b would be roughly located. Note that, in FIG. 3B, it is readily apparent that an overlapping portion of the first cutout 202 and the third cutout 214 of FIGS. 2A and 2B is empty space allowing for the passage of the spring through said empty space. Likewise, an overlapping portion of the second cutout 208 and fourth cutout 220 is likewise empty space, allowing for the passage of the spring through said empty space. These respective empty spaces allow the spring to enclose portions of the first section 200A and second section 200B.

The overlapping portion of the second cutout 208 and fourth cutout 220 is bounded on three sides by the edges of the second cutout 208, and on three sides by the edge of the fourth cutout 220. In some examples, the three sides bounded by the second cutout 208 are different from the three sides bounded by the fourth cutout 220. As a result, the overlapping portion of empty space defined by the second cutout 208 and fourth cutout 220 may be bounded by edges on four sides and/or all sides.

In contrast, the overlapping portion of the first cutout 202 and third cutout 214 is bounded on three sides by the edges of the first cutout 202 and on two sides by the edges of the third cutout 214. As illustrated, the two sides bound by the edges of the third cutout 214 are the same as two of the three sides bound by the edges of the first cutout 202. As a result, the portion of overlapping empty space defined by the edges of the first cutout 202 and third cutout 214 is bound on three sides instead of four. This allows the spring to be easily removed by moving the spring in the unbound direction. However, in some examples, an additional edge of the third cutout 214 may be added (e.g., by reducing the size of the third cutout 214), and the additional edge may be placed such that the portion of the overlapping empty space defined by the edges of the first cutout 202 and third cutout 214 is fully bound on four sides and/or all sides.

The spring exerts an inward biasing force approximately directed to the center of the spring trace 304. As a result, the first section 200A and second section 200B are biased inwardly, to the position of complete overlap illustrated by FIG. 3B, at which point the first section 200A and second section 200B may reach equilibrium, for example, because the spring can no longer bias the first section 200A and second section 200B toward the center of the spring trace 304.

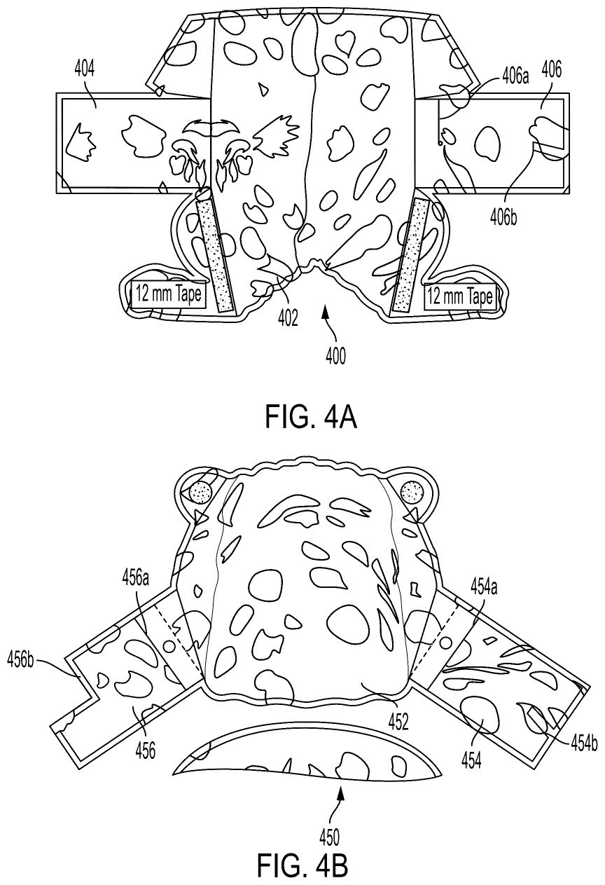

The first section 200A may be coupled to a first part of the paper arrangement 100, and the second section 200B may be coupled to a second part of the paper arrangement 100. The inward biasing force exerted by the spring may therefore pull the first part and the second part of the paper arrangement 100 toward each other, thereby changing the curvature of the paper arrangement 100. This will be discussed in greater detail below, with respect to FIGS. 4A and 4B.

FIGS. 4A and 4B illustrate a front section 400 and a back section 450 of a paper arrangement (for example, paper arrangement 100 or a variation thereof). The front section 400 and back section 450 are configured to be coupled together, and then biased into a position where the first section 400 and second section 450 have curvature (e.g., are not flat).

The front section 400 includes a front body portion 402, a first biasing element 404, and a second biasing element 406. The first biasing element 404 has at least one long edge (“long edge”) and at least one short edge (“short edge”). The second biasing element 406 also has at least one long edge and at least one short edge (“long edge and short edge”). The first biasing element 404 is coupled to a first side of the front body portion 402 via one of the long or short edges of the first biasing element 404. In some examples, the first biasing element 404 is coupled to the first side of the front body portion 402 via the short edge of the first biasing element 404. The second biasing element 406 is coupled to a second side of the front body portion 402 via one of the long or short edges of the second biasing element 406. In some examples, the second biasing element 406 is coupled to the second side of the front body portion 402 via the short edge of the second biasing element 406.

The second biasing element 406 includes a first cutout 406a and a second cutout 406b. The third biasing element 456 includes a first cutout 454a and a second cutout 454b. The fourth biasing element 456 includes a first cutout 456a and a second cutout 456b. The first biasing element 404 does not include a cutout.

The first biasing element 404 may be configured to fold along whichever of its edges is coupled to the front body portion 402 (e.g., the first biasing element 404 may be configured to fold along its short edge). The second biasing element 406 may be configured to fold along whichever of its edges is coupled to the front body portion 402 (e.g., the second biasing element 406 may be configured to fold along its short edge). However, in some examples, at least one of the first biasing element 404 and/or the second biasing element 406 is not as wide as the front body portion 402. That is, when folded along an edge such that the first biasing element 404 and/or second biasing element 406 overlaps with the front body portion 402, one or both of the first biasing element 404 and/or second biasing element 406 may not be long enough to cross the full width of the front body portion 402 when the front body portion 402 is flat. In some examples, the long edge and/or the short edge of either or both of the first biasing element 404 and/or second biasing element 406 may be shorter than the distance between the first side and the second side of the front body portion 402 when the front body portion 402 is flat.

The back section 450 includes similar components compared to the front section 400. The back section 450 includes a back body portion 452, a third biasing element 454, and a fourth biasing element 456. The third biasing element 454 is coupled to a first side of the back body portion 452. The fourth biasing element 456 is coupled to a second side of the back body portion 452. Both the third biasing element 454 and the fourth biasing element 456 may have one or more respective edges, including respective long edges and/or short edges. The third biasing element 454 may be coupled to the back body portion 452 via an edge (for example, a short edge). The fourth biasing element 456 may be coupled to the back body portion 452 via an edge (for example, a short edge). Both the third biasing element 454 and fourth biasing element 456 may be configured to fold along their respective edge coupled to the back body portion 452. The third biasing element 454 may, when folded to overlap the back body portion 452, be too short to traverse the length of the back body portion 452. The fourth biasing element 456 may, when folded to overlap the back body portion 452, be too short to traverse the length of the back body portion 452.

The second biasing element 406, third biasing element 454, and fourth biasing element 456 may be coupled together using the spring. In some examples, the second biasing element 406 and third biasing element 454 may be aligned parallel to one another such that the first cutout 406a of the second biasing element 406 aligns with the first cutout 454a of the third biasing element 454, and the second cutout 406b of the second biasing element 406 aligns with the second cutout 454b of the third biasing element 454. The fourth biasing element 456 may be aligned parallel to the second biasing element 404 and third biasing element 454 such that the first cutout 456a of the fourth biasing element 456 is located in proximity to and/or aligned with the second cutout 406b of the second biasing element 406 and/or the second cutout 454b of the third biasing element 454. Likewise, the second cutout 456b of the fourth biasing element 456 may be aligned with and/or located in proximity to the first cutout 406a of the second biasing element 406 and/or the first cutout 454a of the third biasing element 454. A spring may pass through the aligned cutouts to hold the biasing elements together. For example, a first end of the spring may be aligned with and/or passing through a portion of the first cutout 406a of the second biasing element 406, first cutout 454a of the third biasing element 454, and/or second cutout 456b of the fourth biasing element 456. A second end of the spring may be aligned with and/or passing through a portion of the second cutout 406b of the second biasing element 406, the second cutout 454b of the third biasing element 454, and/or the first cutout 456a of the fourth biasing element 456.

The first biasing element 404 may be coupled, in parallel, with the other biasing elements via an adhesive, pin, or other fixing mechanism. In some examples, the first biasing element 404 will be coupled to the fourth biasing element 456.

As the biasing elements are shorter than the width of the front section 400 and/or back section 450 of the paper arrangement, the front body portion 402 and the back body portion 452 may be biased into a curved position (rather than a flat position) such that the shortest straight-line distance from the first side to the second side of the front body portion 402 and/or back body portion 452 is less than the shortest distance when in a flat position. In some examples, the maximum distance between the first side and the second side of the front body portion 402 and/or back body portion 452 may be proportional to the spring constant of the spring. In some examples, the minimum distance between the first side and the second side of the front body portion 402 and/or back body portion 452 may be equal to or greater than the length of a longest one of the biasing elements.

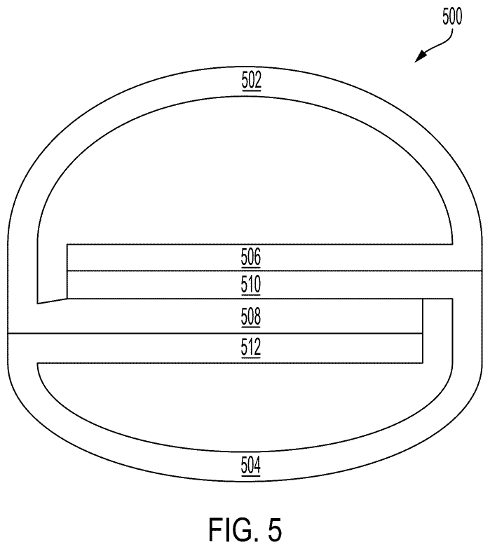

FIG. 5 illustrates a diagram of a paper arrangement 500 from a perspective illustrating curvature of a cross-section of a portion of the paper arrangement 500 in a display position according to an example. The paper arrangement 500 may be an example of the paper arrangement 100 and/or the arrangement of FIGS. 4A and 4B. The paper arrangement 500 includes a front section 502, a back section 504, a first biasing element 506, a second biasing element 508, a third biasing element 510, and a fourth biasing element 512. FIG. 5 may illustrate the curvature of the front body portion 402 and back body portion 452 of the paper arrangement of FIGS. 4A and 4B. In some examples, the front section 502 corresponds to the front body portion 402, first biasing element 506 corresponds to the first biasing element 404, the second biasing element 508 corresponds to the second biasing element 406, the third biasing element 510 corresponds to the third biasing element 454, and the fourth biasing element 512 corresponds to the fourth biasing element 456.

The front section 502 is coupled to the first biasing element 506 and the second biasing element 508. The back section 504 is coupled to the third biasing element 510 and the fourth biasing element 512. The biasing elements 506-512 are relatively straight while the front section 502 and back section 504 are relatively curved (in general, in a direction away from the biasing elements 506-512).

The first biasing element 506 and third biasing element 510 may be coupled together. The second biasing element 508 and fourth biasing element 512 may be coupled together. The second biasing element 508 and third biasing element 510 may be coupled together. In some examples, the biasing elements may be coupled via fasteners (for example, tape or glue) as well as by a spring (for example, the spring indicated by the spring trace 304 of FIGS. 3A and 3B). However, in some examples, the first pair of biasing elements, comprising the first biasing element 506 and third biasing element 510, may be coupled to the second pair of biasing elements, comprising the second biasing element 508 and the fourth biasing element 512, via a mechanism that permits the lateral movement of the pairs of biasing elements with respect to one another. For example, the first pair could be coupled to the second pair via only the spring, which would permit the first pair and second pair to move, subject to the biasing of the spring, with respect to one another.

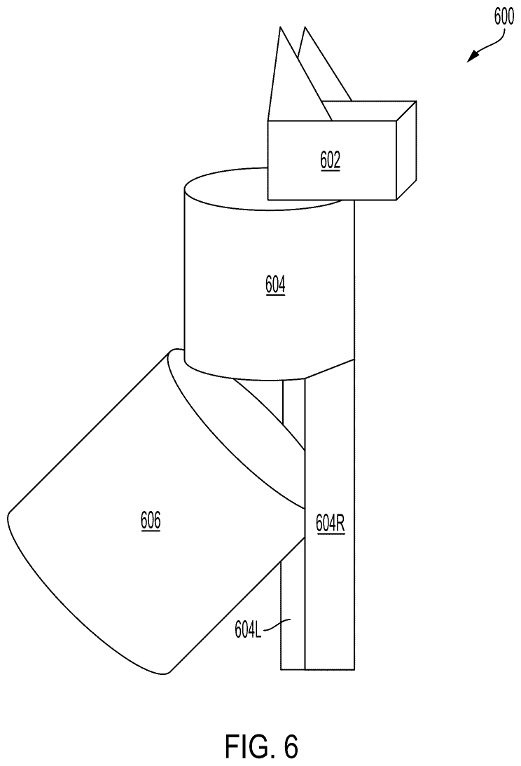

FIG. 6 illustrates a paper arrangement 600 according to an example. FIG. 6 illustrates the paper arrangement 600 as an abstraction, for illustrative purposes. The paper arrangement 600 is configured to look like an animal, for example, a dog or cat. The paper arrangement 600 has three sections that are aligned with one another to create the impression of a lower body, abdomen, and head of the animal. Each of the main sections may include a biasing element designed to bias that particular section into a three-dimensional display state.

The paper arrangement 600 includes three main sections, including a head 602, abdomen 604, and lower body 606. The abdomen further includes a right leg 604R and a left leg 604L.

The head 602 is coupled to an upper portion of the abdomen 604. The lower body 606 is coupled to a lower portion of the abdomen 604. In some examples, the lower body 606 may be coupled to the abdomen 604 at an angle and/or offset, such that a longitudinal axis of the lower body 606 and the longitudinal axis of the abdomen 604 are at different angles relative to the frame-of-reference of the ground. In some examples, the head 602 may be coupled to the abdomen 604 at an angle or offset as well, such that a longitudinal axis of the head 602 and the longitudinal axis of the abdomen 604 are at different angles relative to the frame-of-reference of the ground.

In some examples, the head 602 may be coupled to the abdomen 604 in a fixed manner (e.g., unmoving) or an unfixed manner (e.g., moving). For example, the head 602 may be rotationally, pivotably, slidingly, extendably, and/or otherwise coupled to the abdomen 604. Likewise, the lower body 606 may be fixedly or unfixedly coupled to the abdomen 604, including being rotationally, pivotably, slidingly, extendably, and/or otherwise coupled to the abdomen 604.

The legs 604R, 604L may be coupled to the abdomen 604 such that the legs 604R, 604L extend from the abdomen 604 such that the legs 604R, 604L and/or lower body 606 can all contact the ground at the same time, thus forming a bipod, tripod, or n-pod (having up to n points of contact with the ground) that may act as a base for the paper arrangement 600 and thereby allow the paper arrangement 600 to stand upright when placed on both legs 604R, 604L and/or the lower body 606 at the same time.

Each section 602, 604, 606 may include one or more layers, including respective back layers, front layers, inner layers, outer layers, and so forth.

The relative proportions of each section 602, 604, 606 may be such that they match the proportions of the animal being represented by the paper arrangement 600 (e.g., cat, dog, racoon, giraffe, and so forth) in the position represented by the paper arrangement 600 (e.g., standing, sitting, laying, jumping, running, and so forth). For example, if the paper arrangement 600 represents a sitting dog, the head 602 may be relatively smaller than the abdomen 604 and/or lower body 606, and the abdomen 604 (not counting the legs 604R, 604L) may be relatively smaller than the lower body 606.

Furthermore, although illustrated in FIG. 6 as simple shapes, such as cylinders, rectangles, and so forth, the shape of each section may be complex and multifaceted, to better approximate the animal being represented.

Each section 602, 604, 606 may have individual biasing elements corresponding to it, those respective biasing elements being configured to bias the respective section into the display state. For example, the head 602 may have a head biasing element configured to bias the head into a display state, the abdomen 604 may have an abdomen biasing element configured to bias the abdomen into a display state, and the lower body 606 may have a lower body biasing element configured to bias the lower body into a display state. The head biasing element, abdomen biasing element, and lower body biasing element may all function independently of one another, such that any one or two sections 602, 604, 606 may be biased into the display state while the other two or one sections 602, 604, 606 are not biased into the display state (e.g., are in the storage state). Likewise, all three sections 602, 604, 606 may be biased into the display state simultaneously, or be in the storage state simultaneously.

The sections 602, 604, 606 may be coupled to one another using fasteners, such as tape, glue, hooks, pins, friction fits, and so forth.

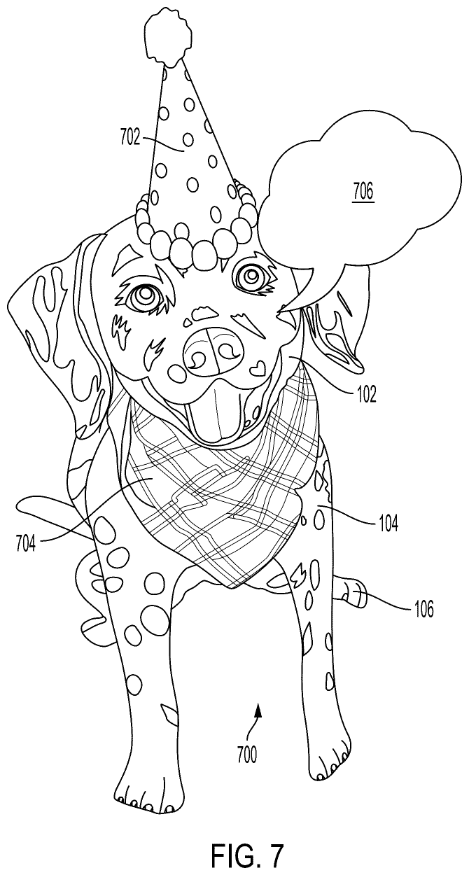

FIG. 7 illustrates a paper arrangement 700 according to an example. The paper arrangement 700 may be similar or identical to the paper arrangement 100 of FIG. 1 in some examples. The paper arrangement 700 includes a plurality of removable accessories, including a first accessory 702, a second accessory 704, and a third accessory 706.

The first accessory 702 may be configured to be selectively coupled to the paper arrangement 700. The first accessory 702 may be selectively coupled to one or more of the first section 102, second section 104, and/or third section 106. The second accessory 704 may be configured to be selectively coupled to the paper arrangement 700. The second accessory 704 may be selectively coupled to one or more of the first section 102, second section 104, and/or third section 106. The third accessory 706 may be configured to be selectively coupled to the paper arrangement 700. The third accessory 706 may be selectively coupled to one or more of the first section 102, second section 104, and/or third section 106.

One or more accessories (e.g., the first accessory 702 and second accessory 704) may be coupled to the paper arrangement 700 at the same time, and may be coupled to the same section 102, 104, 106 and/or different sections 102, 104, 106 at the same time.

Accessories may be coupled via fasteners described herein (e.g., rivets), or may be configured to sit and/or remain in place on the paper arrangement 700 by being fitted to or in the paper arrangement 700 (e.g., via friction or paper slots and/or hooks). The accessories may be any shape, for example, hats, glasses, necklaces, shoes, gloves, wigs, costumes, bowties, speech and/or thought bubbles, and so forth. For example, the first accessory 702 is a hat that has been clipped to the first section 102, the third accessory 706 is a speech bubble (with a space for a person to write or place alphanumeric characters) clipped to the first section 102, and the second accessory 704 is a scarf or bandana clipped to one or both of the first section 102 and/or second section 104.

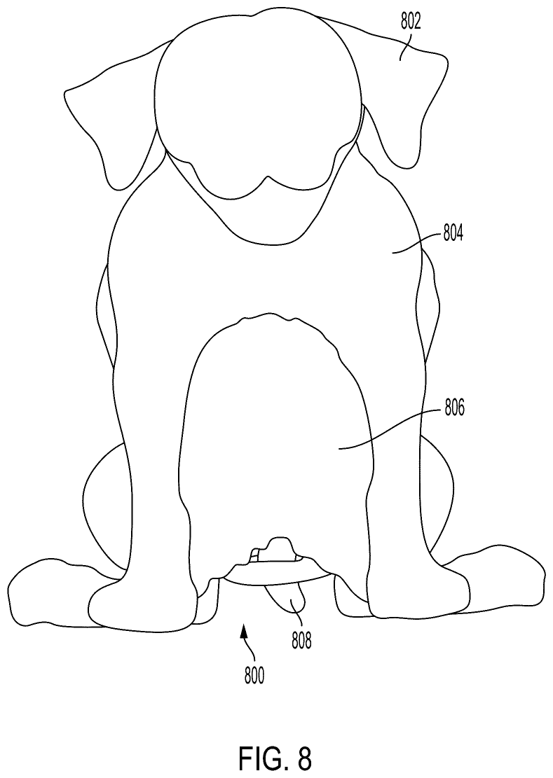

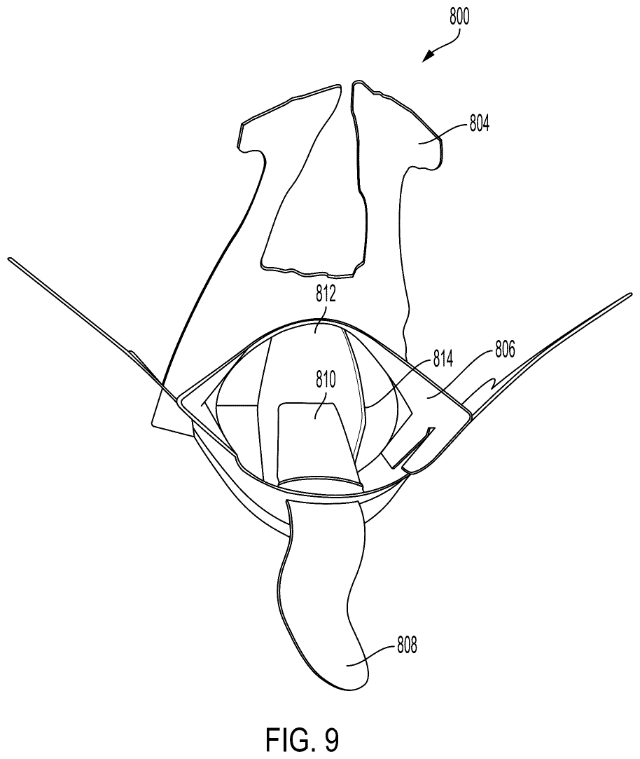

FIG. 8 illustrates a paper arrangement 800 according to an example. The paper arrangement 800 includes a first section 802, a second section 804, and a third section 806. In some examples, the sections 802, 804, 806 are substantially similar to the sections 102, 104, 106 of FIG. 1A. The first section 802 may correspond to the head of an animal, the second section 804 may correspond to the mid-section of an animal, and the third section 806 may correspond to the rear of an animal, e.g., a dog. The paper arrangement 800 also includes a control mechanism 808 for a biasing mechanism (not illustrated) located within one of the sections 802, 804, 806.

The control mechanism 808 may be shaped like a part of the animal or other thing the paper arrangement 800 represents, for example, a tail. The control mechanism 808 may be manipulated to change the state of at least one of the biasing mechanisms located within the paper arrangement 800. By manipulating the control mechanism 808, the paper arrangement 800 switched between the storage state and/or display state.

FIG. 9 illustrates the paper arrangement 800 according to an example. In FIG. 9, internal portions of the third section 806 and/or second section 804 are shown, including a first biasing mechanism 812, a second biasing mechanism 814, and a reinforced portion 810 of the control mechanism 808.

In some examples, the reinforced portion 810, first biasing mechanism 812, and second biasing mechanism 814 are all constituent elements of the same biasing mechanism. The reinforced portion 810 is coupled to the control mechanism 808 and to the first biasing mechanism 812 and/or second biasing mechanism 814. The first biasing mechanism 812 is coupled to at least two points of the third section 806 (though it could equally be coupled to at least two points of the second section 804 or the first section 802 instead, as will be discussed below). The second biasing mechanism 814 is also coupled to at least two point of the third section 806 (though it also could be coupled to at least two points of the second section 804 or first section 802 instead). Note that sections of the paper arrangement 800 (e.g., the first section 802, second section 804, and/or third section 806) may include front and/or back panels which may be distinct pieces.

The first biasing mechanism 812 may be generally circular or disk-like in shape (the other shapes, such as a cross, oval, and so on, are also possible) and may include a fold permitting the first biasing mechanism 812 to fold flush against one or more of the section 802, 804, 806 when the paper arrangement 800 is in the storage state. In some examples, the fold may lie along a line that passes through the center of the first biasing mechanism 812 and orthogonal to a line that lies between the at least two points (which may be located opposite one another, e.g., one of the points on the front and the other at the back of the paper arrangement 800). The first biasing mechanism 812 may be relatively thin compared to the second biasing mechanism 814 in at least one dimension.

The second biasing mechanism 814 may be a ring-like shape situated adjacent (e.g., underneath, relative to the display position of the paper arrangement 800) the first biasing mechanism 812. The sides of the second biasing mechanism 814 may be approximately orthogonal to the plane of the faces of the first biasing mechanism 812 when the paper arrangement 800 is in the display state. The second biasing mechanism 814 may include one or more folds in line with but orthogonal to the fold of the first biasing mechanism 812. In some examples, the second biasing mechanism 814 includes a first fold and a second fold situated in line and orthogonal to the fold of the first biasing mechanism 812, but located on opposite sides of the reinforced portion 810 from one another. These folds may permit the second biasing mechanism 814 to fold flush against one or more of the sections 802, 804, 806 when the paper arrangement 800 is in the storage state.

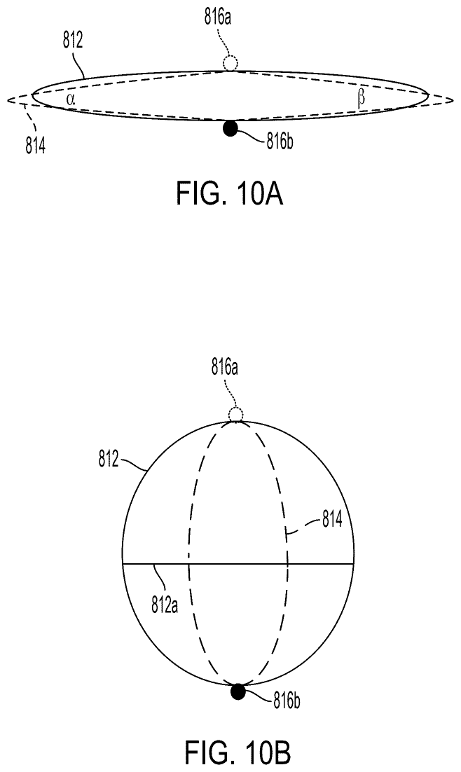

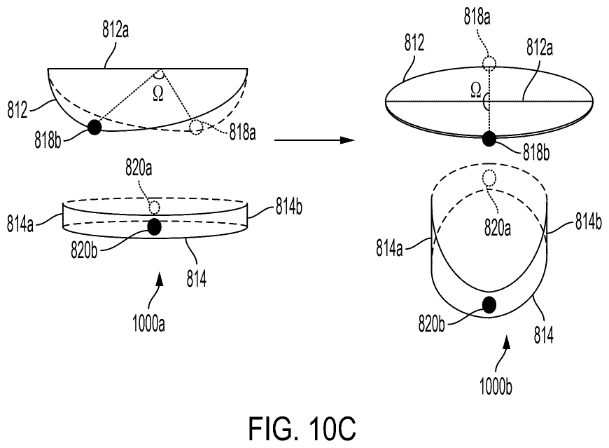

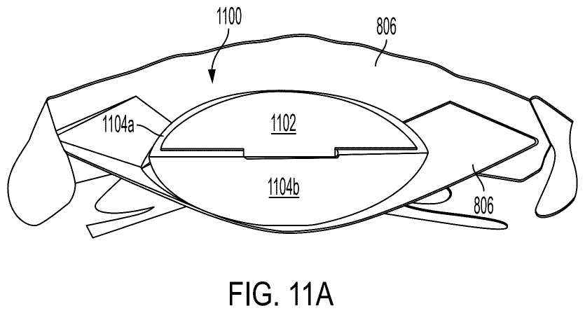

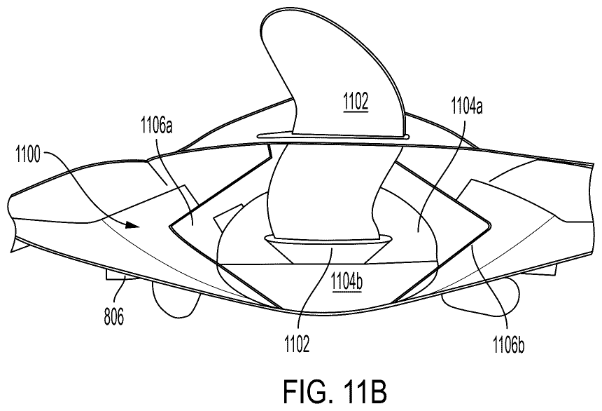

When in the display state, the second biasing mechanism 814 is positioned to prevent the first biasing mechanism 812 from folding too far, as will be discussed below with respect to FIGS. 10A-10D. By preventing the first biasing mechanism 812 from folding too far, the paper arrangement 800 may be kept or held in the display state without collapsing.

The reinforced portion 810 may be optional in some examples. The reinforced portion may be coupled between the first biasing mechanism 812 and the control mechanism 808 to add structural reinforcement so as to prevent the control mechanism 808 from tearing off the first biasing mechanism 812. This permits, in some examples, the control mechanism 808 to be made from a more flexible type of paper. As the control mechanism 808 may be shaped like a tail, other extremity and/or part of an animal, and/or any other object (including a non-animal object that may and/or may not be part of the animal portion of the paper arrangement 800), the reinforced portion 810 thereby permits the control mechanism 808 to remain relatively flexible and easy to manipulate while also ensuring the connection between the control mechanism 808 and the first biasing mechanism 812 is strong. However, in some examples, the control mechanism 808 may be made from stronger paper or other material and the reinforced portion 810 may be omitted if desired. The reinforced portion 810 may also be omitted if the design does not call for the reinforced portion 810.

FIG. 10A illustrates the operation of the biasing mechanisms 812, 814 of FIG. 9 according to an example from a top down perspective (e.g., the first biasing mechanism 812 is above the second biasing mechanism 814). FIG. 10A shows the first biasing mechanism 812, the second biasing mechanism 814, a first attachment point 816a, and a second attachment point 816b.

The attachment points 816a, 816b correspond to where the biasing mechanisms 812, 814 are coupled to front and back portions of a given section 802, 804, 806 of the paper arrangement 800. FIG. 10A illustrates the biasing mechanisms 812, 814 in the storage state (though not necessarily to scale). In the storage state, the angles α and β may relatively small (e.g., 0 degrees or approximately 0 degrees, less than 1 degree, less than 5 degrees, and so forth). Thus the distance between the connection points 816a, 816b may be relatively small (e.g., close to zero meters, or some other small value, such as 1 mm, 10 mm, 20 mm, and so forth). The distance between the connection points 816a, 816b may depend on the thickness of the biasing mechanisms 812, 814.

FIG. 10B illustrates the operation of the biasing mechanisms 812, 814 of FIG. 9 in the display state according to an example from a top down perspective, as in FIG. 10A. FIG. 10B also shows the fold 812a in the first biasing mechanism 812.

FIG. 10C illustrates the first biasing mechanism 812 and second biasing mechanism 814 in the storage state 1000a and/or a folded state compared to the display state 1000b according to an example. FIG. 10C includes attachment points 818a and 818b of the first biasing mechanism 812, and attachment points 820a and 820b and folds 814a and 814b of the second biasing mechanism 814. The attachment points 818a, 818b represent at least two points where the first biasing mechanism 812 is attached to a section 802, 804, 806, and the attachment points 820a, 820b represent at last two points where the second biasing mechanism 814 is attached to a section 802, 804, 806.

The first biasing mechanism 812 is folded, such that the angle, Ω, which may be an angle between the first attachment point 818a and the second attachment point 818b (and therefore between the section of the first biasing mechanism 812 on either side of the fold 812), may be zero, close to zero, or small (e.g., less than 5 degrees, less than 10 degrees, and so forth). In The fold 812a of the first biasing mechanism 812 may be located relatively above the attachment points 818a, 818b and the second biasing mechanism 814. The second biasing mechanism 814 may be located below the first biasing mechanism 814.

The distance between the first connection point 820a and the second connection point 820b of the second biasing mechanism 814 in the storage stage 1000a may be minimal (e.g., zero or near zero, for example, 1 mm, 5 mm, 10 mm, and so forth). The distance between the folds 814a, 814b of the second biasing mechanism 814 may be relatively large compared to in the display state 1000b, and the distance between the folds 814a, 814b may be equal to or approximately equal to (e.g., within a few millimeters) the length of the fold 812a of the first biasing mechanism 812.

In the display state 1000b, the control mechanism 808, being coupled to the first biasing mechanism 812, may pull the first biasing mechanism 812 down, thereby causing the angle, Q, to increase to greater than 180 degrees or greater than approximately 180 degrees (e.g., 175 degrees, 160 degrees, 185 degrees, 190 degrees, and so forth). As the connection points 818a, 818b are fixed to the interior of a section 802, 804, or 806, the angle Ω increasing pushes the sides of the section 802, 804, 806 outward, causing the volume of the paper arrangement 800 to increase. When the angle Ω exceeds 180 degrees, it could in some examples continue to increase (to approximately 360 degrees) but for the presence of the second biasing mechanism 814.

As the second biasing mechanism is also fixed, via attachment points 820a, 820b to a section 802, 804, or 806, and in many examples to the same section as the first biasing mechanism 812, the attachment points 820a, 820b are forced away from each other as the first biasing mechanism 812 unfolds. This correspondingly brings the folds 814a, 814b of the second biasing mechanism 814 closer to one another. However, as the length of the fold 812a of the first biasing mechanism 812 does not change, this means the distance between the folds 814a, 814b of the second biasing mechanism are now less than the length of the fold 812a. Thus, the second biasing mechanism 814 acts as a barrier, preventing the angle Ω from increasing beyond a maximum value. The maximum value of Ω will be related to the distance between the first biasing mechanism 812 and the second biasing mechanism 814 according to geometric principles. The maximum value of Ω may be determined to be approximately 190 degrees, 195 degrees, 270 degrees, and so forth, and may be any value greater than 180 degrees.

As a result of the force applied by the control mechanism 808 to unfold the first biasing mechanism 812, the fold 812a may ultimately be below the connection points 818a, 818b and above or flush with the top of the second biasing mechanism 814. In some examples, there is no internal restoring force that would cause Ω to decrease once Ω exceeds approximately 180 degrees (though when Ω is less than 180 degrees it may naturally decreases toward some smaller value, such as 0 degrees, 5 degrees, 15 degrees, and so forth). Thus, the second biasing mechanism 812 may reach a steady state, where the angle Ω is slightly greater than 180 degrees (e.g., 185 degrees, 190 degrees, 270 degrees, and so forth) but cannot further increase due to the second biasing mechanism's 814 physical presence, and cannot decrease due to the lack of a sufficient restoring force. As a result, the section 802, 804, 806 of the paper arrangement 800 containing the biasing mechanism may be biased into the display state 1000b until an outside force acts as a restoring force to cause Ω to decrease.

In some examples, the biasing mechanism 812 need not be coupled to the control mechanism 808 or reinforced section 810. In such cases, another tool, or even the user (e.g., using a finger) may bias the first biasing section 812 into the display state. In some paper arrangements 800 the control mechanism 808 may be used to control the biasing mechanism 812 when the biasing mechanism 812 is not conveniently accessible, while the control mechanism 808 may be omitted when the biasing mechanism 812 is conveniently accessible. In some examples, a paper arrangement 800 may have multiple biasing mechanisms 812, 814 in different section, with some of the first biasing mechanisms 812 being conveniently accessible and/or omitting a control mechanism 808, and others being inconvenient or impossible to access and thus including a control mechanism 808.

In some examples, a control mechanism, such as the control mechanism 808, may instead be used to change the position of the second biasing mechanism 814, however it will be readily apparent that the ultimate effect will be to cause the first biasing mechanism 812 to unfold until it reaches the steady state position as described above.

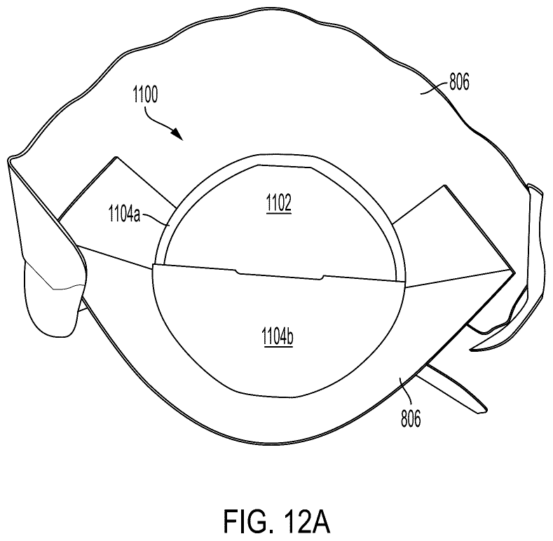

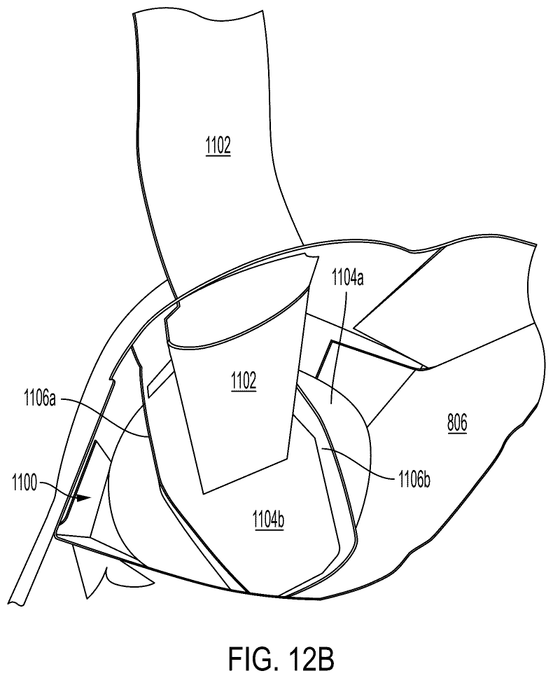

FIGS. 11A and 11B illustrate a biasing mechanism 1100 according to an example. The biasing mechanism 1100 may be one example of the biasing mechanism of the paper arrangement 800 of FIGS. 8 through 10C. FIGS. 12A and 12B illustrate the same biasing mechanism 1100. The principal difference is that in FIGS. 11A and 11B the biasing mechanism 1100 is folded (e.g., not in the display state, though not necessarily in the storage state), while in FIGS. 12A and 12B the biasing mechanism 1100 is in the display state.

Furthermore, the FIGS. 11A through 12B display the biasing mechanism 1100 from different perspectives. FIGS. 11A and 12A both illustrate the biasing mechanism 1100 from a top-down perspective, while FIGS. 11B and 12B both illustrate the biasing mechanism 1100 from a bottom-up perspective. The FIGS. 11A-12B thereby illustrate the operation of the biasing mechanism 1100 according to an example.

FIG. 11A illustrates the biasing mechanism 1100 from a top-down perspective according to an example. The biasing mechanism 1100 includes a control mechanism 1102, a first disk section 1104a, and a second disk section 1104b. The third section 806 of the paper arrangement 800 is also shown to contextualize the placement of the biasing mechanism 1100 within a given section of the paper arrangement 800. It is to be understood that the biasing mechanism 1100 can be placed in other sections of the paper arrangement 800.

The first disk section 1104a is coupled to the controller 1102 and to the third section 806. The second disk section 1104b is coupled to the third section 806. The second disk section 1104b may be coupled to the third section 806 at a point or points opposite the point or points at which the first disk section 1104a is coupled to the third section 806. The first disk section 1104a and second disk section 1104b are coupled to each other at or near a fold that runs approximately through the (or a) center axis across the surface of the disk formed by the disk sections 1104a, 1104b. As illustrated in FIG. 11A (as will be contrasted in FIG. 12A), the disk sections 1104a, 1004b appear to form an ovoid shape. This is because the two disk section 1104a, 1104b are position at an angle to one another, such that the portions of each disk section 1104a, 1004b nearest the fold are above (e.g., closer to the viewpoint of the image) compared to the portions of the disk sections 1104a, 1004b coupled to the third section 806.

FIG. 11B illustrates the biasing mechanism 1100 from a bottom-up perspective according to an example. FIG. 11B further illustrates a first ring section 1106a and a second ring section 1106b.

The first ring section 1106a is coupled to the second ring section 1106b in two regions including a first region at one end of the first ring section 1106a and the second ring section 1106b, and at a second region at the other end of the first ring section 1106a and the second ring section 1106b. The first ring section 1106a is also coupled to the third section 806. The second ring section 1106b is also coupled to the third section 806 at a point opposite to that of the first ring section 1106a.

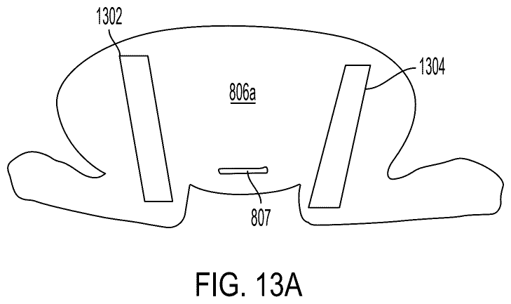

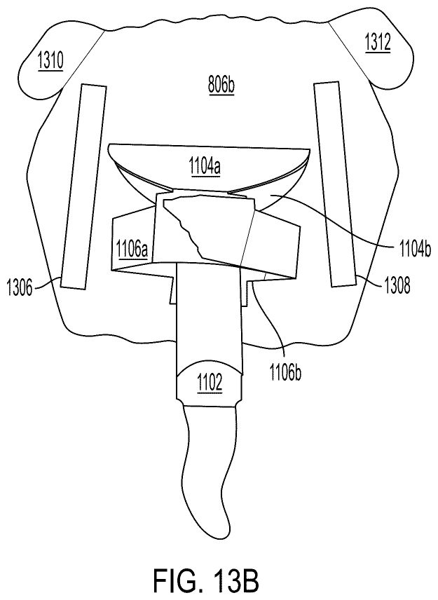

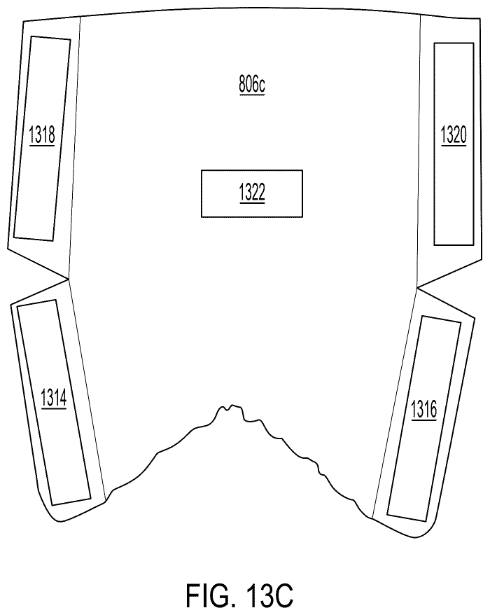

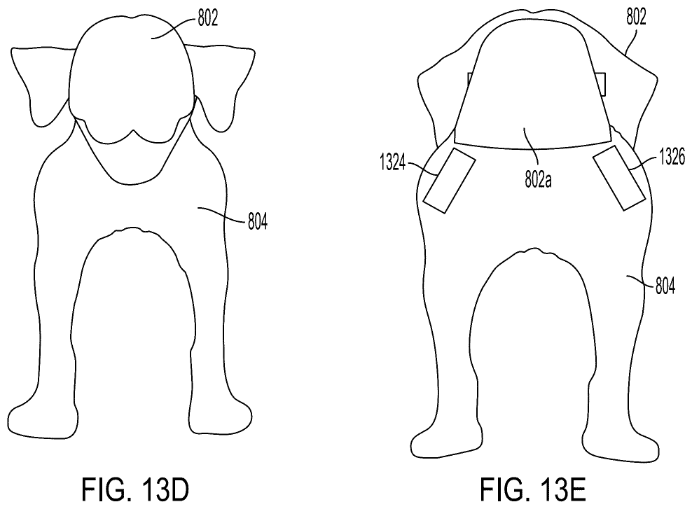

In some examples, the control mechanism 1102 passes through a slot or hole in the disk sections 1104a, 1104b, and out through a slot or hole in the in the back of the third section 806 (e.g., slot 807 of FIG. 13A). The control mechanism 1102 may be pulled (e.g., by the part passing through the slot in the third section 806) to cause the disk sections 1104a, 1104b to unfold and transition into the display state (as described in FIGS. 12A and 12B).

As can be seen, the ring sections 1106a and 1106b form a sort of diamond shape. As the biasing mechanism 1100 is folded into the storage state, the diamond shape will transition into a pair of approximately parallel ring sections connected at either end and running parallel to the widest faces of the control mechanism 1102. The first ring section 1106a may become adjacent to the face of the control mechanism 1102 on the same side as the first disk section 1104a, while the second ring section 1106b may become adjacent to the face of the control mechanism 1102 on the same side as the second disk section 1104b.

FIG. 12A illustrates the biasing mechanism 1100 from the top-down perspective in the display state according to an example.

As can be seen in FIG. 12A, the disk sections 1104a, 1104b now describe a more circular shape compared to FIG. 11A. In some examples, this is because the fold and the points at which the first and second disk sections 1104a, 1104b are coupled to the third section 806 are in the same plane or approximately in the same plane. In some examples, the fold may be slightly lower (that is, further from the viewpoint of FIG. 12A) that the points at which the first and second disk sections 1104a, 1104b are coupled to the third section 806.

The biasing mechanism 1100, specifically, the disk sections 1104a, 1104b, force interior regions of the third section 806 away from each other, thus increasing the volume of the third section 806.

FIG. 12B illustrates the biasing mechanism 1100 from a bottom-up perspective according to an example.

As can be seen, the disk sections 1104a, 1104b describe a more circular shape as described above, with respect to FIG. 12A. The ring sections 1106a, 1106b now describe a somewhat rectangular shape that straddles the thinnest sides (as opposed to the widest faces) of the control mechanism 102. The regions where the first ring section 1104a and second ring section 1104b are coupled to one-another are now situated close to the thinnest sides of the control mechanism 1102.

From FIGS. 11A through 12B, the operation of the control mechanism 1102 can be understood. When the control mechanism 1102 is pulled downward (e.g., away from the viewpoint in FIG. 11A or FIG. 12A), the portion of the control mechanism 1102 coupled above the first disk section 1104a pulls the first disk section 1104a down. Because the first disk section 1104a is coupled to the second disk section 1104b, the second disk section 1104b is also pulled down. Because the disk sections 1104a, 1104b are coupled to the third section 806, the regions of the disk sections 1104a, 1104b closer to the fold are pulled down more than those closer to the third section 806. As the disk sections 1104a, 1104b move down, forcing regions of the third section 806 further apart, the ring sections 1106a, 1106b are moved into the position illustrated in FIG. 12B—that is, the ring sections 1106a, 1106b are pulled into the generally rectangular arrangement. The ring sections 1106a, 1106b prevent the disk sections 1104a, 1104b from moving further in the downward direction, and thus the biasing mechanism 1100 is locked in place (as the fold is below the points where the disk sections 1104a, 1104b are coupled to the third section 806 and there is no restoring force in the opposite direction.

The process described above is then reversed when the control mechanism 1102 is pushed upward (e.g., toward the viewpoint in FIG. 11A or FIG. 12A). Pushing the control mechanism 1102 upward causes the disk sections 1104a, 1104b to fold, thus causing the fold to move to a position above the points where the disk sections 1104a, 1104b are coupled to the third section 806. The ring sections 1106a, 1106b are forced back to the more diamond-like arrangement described with respect to FIG. 11B as the sides of the third section 806 move closer together.

The control mechanism 1102 may be omitted. While the control mechanism 1102 is a convenient way to control the position of the disk sections 1104a, 1104b, the disk sections 1104a, 1104b may also be manipulated via other means (e.g., by a user's hand).

FIGS. 13A-13E illustrate the paper arrangement 800 in a disassembled state according to an example. FIGS. 13A-13E display various components of the paper arrangement 800 shown individually or in pieces, according to an example.

FIG. 13A illustrates a first back portion 806a of the third section 806 according to an example. The first back portion 806a includes a first connection region 1302 and a second connection region 1304. The first back portion 806a may also include a slot 807 for the control mechanism 1102. The connection regions may be regions where an adhesive, or other type of fixing substance or mechanism, is located. The first and second connection regions 1302, 1304 may be regions at which the first back portion 806a of the third section 806 are connected to the front portion 806c of the third section 806.

FIG. 13B illustrates a second back portion 806b of the third section 806 according to an example. The second back portion 806b includes a third connection region 1306, a fourth connection region 1308, a fifth connection region 1310, a sixth connection region 1312, and may be coupled (e.g., via an adhesive) to the elements of the biasing mechanisms 1104a, 1104b, 1106a, 1106b of FIGS. 11A through 12B. The third and fourth connection regions 1306, 1308 may be regions at which the second back portion 806b is coupled to the front portion 806c, for example, via an adhesive or other fixing substance or mechanism. The fifth and sixth connection regions 1310, 1312 may be regions where the second back portion 806b is connected to the first or second section 802, 804.

FIG. 13C illustrates the front portion 806c of the third section 806 according to an example. The front portion 806c includes a seventh connection region 1314, an eighth connection region 1316, a ninth connection region 1318, a tenth connection region 1320, and an eleventh connection region 1322. The connection regions 1314, 1316, 1318, 1320 may be regions where an adhesive or other fixing substance or mechanism are located. In some examples, the seventh connection region 1314 is configured to couple to the second connection region 1304, the eighth connection region 1316 is configured to couple to the first connection region 1302, the ninth connection region 1318 is configured to couple to the fourth connection region 1308, and the tenth connection region 1320 is configured to couple to the third connection region 1306. The eleventh connection region 1322 may be configured to couple to one of the ring sections 1106a, 1106b and/or one of the disk sections 1104a, 1104b.

FIG. 13D illustrates the first section 802 and second section 804 from the front according to an example.

FIG. 13E illustrates the first section 802 and second section 804 from the back according to an example. The second section 804 includes a twelfth connection region 1324 and a thirteenth connection region 1326. The twelfth and thirteenth connection regions 1324, 1326 may be regions corresponding to an adhesive or other fixing substance or mechanism. The twelfth connection region 1324 may be configured to be coupled to the sixth connection region 1312, and the thirteenth connection region 1326 may be configured to be coupled to the fifth connection region 1310.

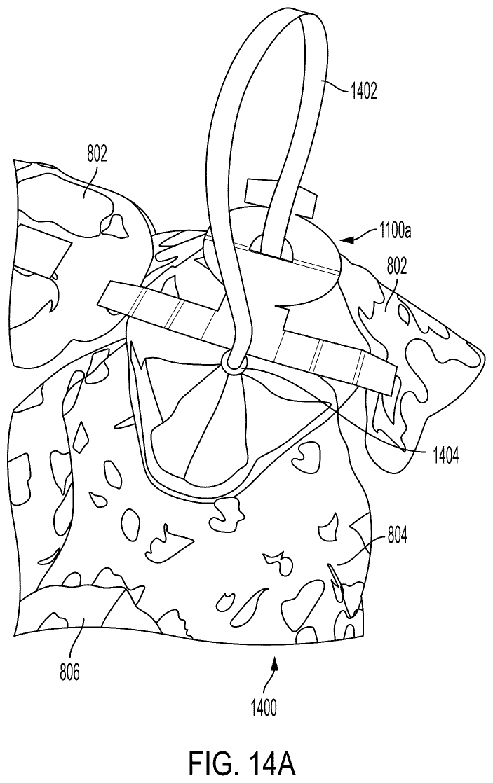

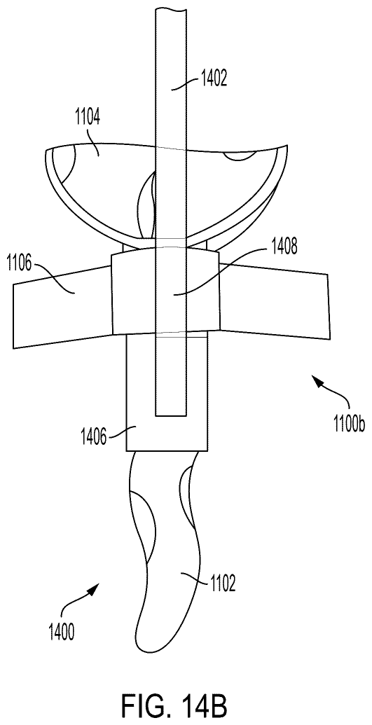

A conical portion 802a of the first section 802 may contain a biasing mechanism, such as those disclosed herein. Likewise, the “face” of section 802 may contain a biasing mechanism such as those disclosed herein. The first section 802 may be coupled to the second section 804 via adhesive elements, rivets, or other fasteners as discussed herein, the fastener and/or fasteners being located within the conical portion 802a, which may overlap with parts of the second section 804. FIG. 14A illustrates an example of a paper arrangement 1400 which is similar to the paper arrangement 800 of FIG. 8, but incorporates a strap 1402 for connecting a biasing mechanism 1100 located in the first section 802 to the controller located in the third section 806. The paper arrangement 1400 is represented in a partially assembled state in FIG. 14A, where the first biasing mechanism 1100a is unfolded, and where the first section 802 is also unfolded. The paper arrangement 1400 includes a first section 802, a second section 804, a third section 806, a first biasing mechanism 1100a located in the first section 802, a second biasing mechanism 1100b located in the third section 806, a rivet 1404, and a strap 1402 that is coupled to the first biasing mechanism 1100a and to a controller 1102b of the second biasing mechanism 1100b. The biasing mechanisms 1100a, 1100b may be implemented using the design of the biasing mechanism 1100 described herein.

The rivet 1404 couples the first section 802 to the third section 806 (and may also couple the second section 804 to the first section 802 and/or third section 806). The rivet 1404 may be a ring-shaped rivet with a hole through its center. The strap 1402 may be coupled to the first biasing mechanism 1100a (e.g., to one of the disk sections of the first biasing mechanism 1100a), such that when the strap 1402 is under sufficient tension, the disk sections of the first biasing mechanism 1100a are pulled down (e.g., as described with respect to FIG. 10C, where the angle increases to approximately 180 degrees), thus biasing the first biasing mechanism 1100a into the display state.

The strap 1402 may be placed under sufficient tension by manipulating the controller of the second biasing mechanism 1100b situated within the third section 806, as described in greater detail with respect to FIG. 14B.

FIG. 14B illustrates the second biasing mechanism 1100b, including a disk section 1104 (which may be, in some examples, either the first disk section 1104a or second disk section 1104b), a ring section 1106 (which may be, in some examples, either the first ring section 1006a or the second ring section 1106b), the controller 1102, and a reinforced section 1406. The third section 806, which would normally encapsulate the second biasing mechanism 1100b, is not shown. The strap 1402 is shown, along with a strap trace 1408.

The reinforced section 1406 is coupled to the controller 1102, and may be coupled to a portion of the controller 1102 located inside the third section 806. The reinforced section 1406 may also be coupled to the strap 1402 as indicated by the strap trace 1408 (which shows where the strap 1402 is located but not visible). The strap 1402 enters the third section 806 through the hole (e.g., in the rivet 1404). The strap 1402 then passes through a slot along the fold between the disk sections of the biasing mechanism 1100b, and through the center of the ring sections, before terminating at the reinforced section.

When the controller 1102 is pulled, thereby biasing the second biasing mechanism 1100b into the display state, the strap 1402 is put under sufficient tension to bias the first biasing mechanism 1100a into the display state. As a result, a single controller 1102 can control both the first and second biasing mechanisms 1100a, 1100b. In some examples, when the first biasing mechanism 1100a is reverted to the storage state (e.g., because a user pulls it back into the storage position), the strap 1402 will exert tension on the controller 1102, pulling the controller 1102 back to the original position and biasing the second biasing mechanism 1100b into the storage state.

In some examples, the strap 1402 may be a fabric, plastic, or paper. In some examples, the strap 1402 may be coupled to multiple biasing mechanisms 1100 or multiple straps 1402 may be coupled in a daisy-chain configuration to multiple biasing mechanisms 1100. As a result, a single controller 1102 may be used to control the state of multiple biasing mechanisms 1100.

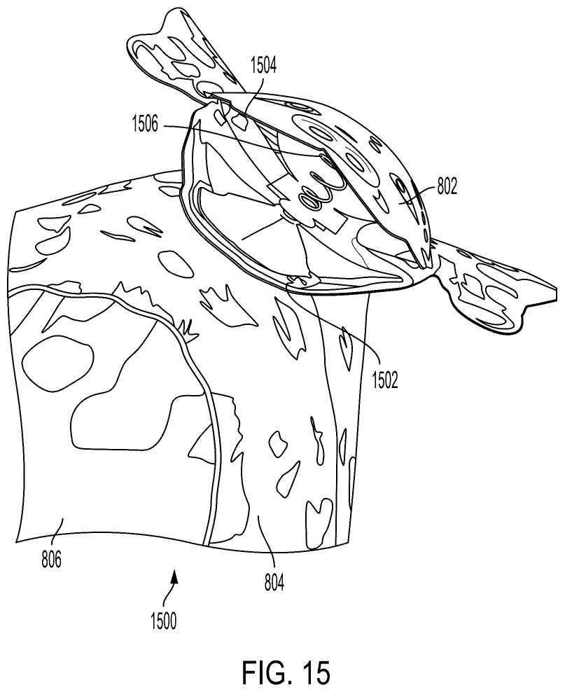

FIG. 15 illustrates a paper arrangement 500 having a biasing mechanism 1506 according to an example. The biasing mechanism 1502 is coupled to a first inner face 1502 of the first section 802 and/or to a second inner face 1504 of the first section 802.

The biasing mechanism 1506 may be configured to bias the first inner face 1502 of the first section 802 away from the second inner face 1504 of the first section 802. The first inner face 1502 may be situated opposite the second inner face 1504, thus, when the biasing mechanism 1506 is in an equilibrium or near equilibrium state, the biasing mechanism 1506 forces the inner faces 1502, 1504 away from each other and into the display state. A counter force may be applied to the biasing mechanism 1506 to compress the biasing mechanism 1506 and bring the inner faces 1502, 1504 together or closer together. In some examples, the biasing mechanism 1506 may be a spring. In some examples, the biasing mechanism 1506 may be coupled to a central or approximately central location of the inner face and/or inner faces 1502, 1504 to which the biasing mechanism 1506 is coupled.

In various examples, other types of biasing mechanism 1506 may be used instead of a spring.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A three-dimensional paper arrangement comprising:
at least one section including a first section, the first section having an internal space between a front portion of the first section and a back portion of the first section;
a first biasing mechanism coupled to the front portion at a first location and coupled to the back portion at a second location opposite the first location;
a second biasing mechanism coupled to the front portion at a third location and coupled to the back portion at the fourth location opposite the third location; and
a control mechanism coupled to the first biasing mechanism and configured to selectively adjust the first biasing mechanism into a first position or a second position, the first position biasing the first location and second location away from each other.

2. The three-dimensional paper arrangement of claim 1 wherein the first biasing mechanism includes a fold separating the first biasing mechanism into a first half and a second half, wherein in the first state an angle between the first half and the second half is approximately 180 degrees.

3. The three-dimensional paper arrangement of claim 1 wherein the first biasing mechanism includes a fold separating the first biasing mechanism into a first half and a second half, wherein in the second state an angle between the first half and the second half is less than 5 degrees.

4. The three-dimensional paper arrangement of claim 1 wherein the second biasing mechanism is situated adjacent to the first biasing mechanism in the first position.

5. The three-dimensional paper arrangement of claim 1 wherein the second biasing mechanism includes a first half and a second half, the first half extending from the third location to the fourth location on a first of the control mechanism, and the second half extending from the third location to the fourth location on a second side of the control mechanism.

6. The three-dimensional paper arrangement of claim 5 wherein, when the first biasing mechanism is in the first position, the first half of the second biasing mechanism extends laterally between the third position and the fourth position below the first biasing mechanism, and the second half extends laterally between the third position and the fourth position below the first biasing mechanism.

7. The three-dimensional paper arrangement of claim 1 wherein the first biasing mechanism is a disk and the second biasing mechanism is a ring.

8. The three-dimensional paper arrangement of claim 1 further comprising a second section including a third biasing mechanism, the third biasing mechanism configured to bias the second section into a three-dimensional position, the third biasing mechanism being coupled to the control mechanism via a strap.

9. The three-dimensional paper arrangement of claim 1 wherein the first section occupies a greater total volume in the first position than in the second position.

10. The three-dimensional paper arrangement of claim 1 wherein the paper arrangement is configured to resemble an animal.

11. The three-dimensional paper arrangement of claim 1 including a second section, wherein the first section resembles the lower body of an animal and the second section resembles the upper body of an animal, the second section including a respective first biasing mechanism and a respective second biasing mechanism.

12. The three dimensional paper arrangement of claim 11 wherein the second section is pivotably coupled to the first section.

13. A three-dimensional paper arrangement comprising:
a front side;
a back side;
an internal space between the front side and the back side;
a biasing device situated within the internal space and coupled to the front side and the back side, the biasing device including a disk element and a ring element, the disk element being coupled to the front side at a first location and to the back side at a second location, and the ring element being coupled to the front side at a third location and to the back side at a fourth location, the disk element including a fold separating the disk element into a first half and a second half.

14. The three-dimensional paper arrangement of claim 13 wherein, in the first position, an angle between the first half and the second half is less than 5 degrees, a first distance, between a first point where the ring element is coupled to the front side and a second point where the ring element is coupled to the back side, is less than in the second position, and a second distance, between a first region of the ring element located halfway between the first point and the second point and a second region of the ring element located halfway between the first point and the second point and opposite the first region, is greater than in the second position.

15. The three-dimensional paper arrangement of claim 14 wherein, in the second position, the angle between the first half and the second half is approximately 180 degrees, and the first region and second region are directly below the disk element.

16. The three-dimensional paper arrangement of claim 14 further comprising a control mechanism coupled to the disk element, the control mechanism extending out of the interior space.

17. The three-dimensional paper arrangement of claim 16 wherein the disk element includes a slot situated along the fold, the control mechanism passing through the fold and being coupled to the disk element on a side of the disk element opposite the ring element.

18. The three-dimensional paper arrangement of claim 16 further comprising a second internal space having a second biasing device, the second biasing device being coupled to the control mechanism via a strap configured to allow the control mechanism to control a state of the second biasing device.

19. A paper arrangement comprising:
a paper upper body configured to resemble the upper body of an animal;
a paper lower body configured to resemble the lower body of an animal; and
a biasing mechanism coupled within one of the paper upper body or the paper lower body and configured to bias the paper upper body or paper lower body into a display state, the biasing mechanism including a disk element and a ring element.

20. The paper arrangement of claim 19 wherein at least one feature of the paper upper body or the paper lower body is operative to control the position of the disk element of the biasing mechanism.
